(19) United States
(12) Patent Application Publication
(10) Pub. No.: US 2011/0158072 A1
(43) Pub. Date: Jun. 30, 2011

(54) METHOD OF DETECTING APPROXIMATE TOUCH-DOWN, METHOD OF ADJUSTING HEAD FLYING HEIGHT USING THE DETECTED APPROXIMATE TOUCH-DOWN, AND DISK DRIVE

(75) Inventors: Kyoung-whan OH, Seoul (KR); Jung-dae Kim, Bucheon-si (KR); Bong-jin Lee, Seoul (KR)

(73) Assignee: Samsung Electronics Co., Ltd., Suwon-si (KR)

(21) Appl. No.: 12/981,807

(22) Filed: Dec. 30, 2010

(30) Foreign Application Priority Data
Dec. 30, 2009 (KR) 2009-134933

(51) Int. Cl. G11B 21/12; G11B 5/455

(52) U.S. Cl. 369/53.38; 360/75; G9B/21.021; G9B/5.145

(57) ABSTRACT

A method and apparatus to control a flying height of a head in a disk drive by detecting a flying state of the head just before it touches down to a disk. The method includes detecting approximate touch-down based on detecting a motion change of a head in a disk track direction by changing a flying height of the head on a rotating disk and determining that the head approaches a touch-down approximated flying height when the detected motion change of the head in the disk track direction exceeds a threshold value.

### CROSS-REFERENCE TO RELATED APPLICATIONS

This application claims priority under 35 U.S.C. §119(a) from Korean Patent Application No. 10-2009-0134933, filed on Dec. 30, 2009, in the Korean Intellectual Property Office, the disclosure of which is incorporated herein in its entirety by reference.

### BACKGROUND

1. Field of the Invention

The general inventive concept relates to a method and apparatus to control a flying height of a head in a disk drive, and more particularly, to a method and apparatus to control a flying height of a head by detecting a flying state of a head just before the head in a disk drive touches down to a disk

2. Description of the Related Art

In general, a hard disk drive, which is a data storage device, is connected to a host device and writes data on a recording medium or reads data written on a recording medium according to instructions of the host device. According to a gradual increase in capacity and density, and a decrease in the size of the disk drive, bits per inch (BPI), which is the density in a disk rotating direction, and track per inch (TPI), which is the density in a radial direction, are increasing and thus a detailed mechanism control for the disk drive is required.

Accordingly, research into accurately measuring and adjusting a flying height, which is a distance between the head and the disk and affects the performance of the disk drive, without damage to the disk and the head, is required.

### SUMMARY

The general inventive concept provides a method of detecting approximate touch-down of a head in a disk drive to detect a flying state of the head just before it is touched down to a disk.

Additional features and utilities of the present general inventive concept will be set forth in part in the description which follows and, in part, will be obvious from the description, or may be learned by practice of the present general inventive concept.

The general inventive concept provides a method of adjusting a head flying height by detecting a flying state of a head in a disk drive just before the head is touched down to a disk.

The general inventive concept provides a disk drive that adjusts a head flying height by using the method of detecting approximate touch-down to detect a flying state of a head in a disk drive just before the head is touched down to a disk.

The general inventive concept provides a storage medium having recorded thereon a program code to execute the method of detecting approximate touch-down to detect a flying state of a head in a disk drive just before the head is touched down to a disk and the method of adjusting a head flying height by using the detected approximate touch-down.

According to a feature of the general inventive concept, there is provided a method of detecting approximate touch-down of a head in a disk drive, the method including detecting a motion change of the head in a disk track direction by changing a flying height of the head over a rotating disk; and determining that the head approaches a touch-down approximated flying height when the detected motion change of the head in the disk track direction exceeds a threshold value.

The motion change of the head in the disk track direction may be detected by using a change in a time interval between servo patterns detected from the disk according to a change in the flying height of the head

The flying height of the head may be changed by changing a voltage or current of a first signal applied to a heater installed in the head.

The detecting of the motion change of the head in the disk track direction may include: outputting information about a time interval between servo patterns detected from the disk by the head in a condition where the first signal is applied by changing a magnitude of the first signal and in a condition where the first signal is not applied, wherein the first signal is used to adjust the flying height of the head; and outputting the motion change of the head in the disk track direction by using a change between information about a time interval between servo patterns output in the condition where the first signal is applied and information about a time interval between servo patterns output in the condition where the first signal is not applied.

The motion change of the head in the disk track direction may be output by performing fast Fourier transformation (FFT) for information in a time interval between servo patterns detected while repeating the condition where the first signal is applied and the condition where the first signal is not applied.

The motion change of the head in the disk track direction may be output by calculating a difference between an average value of the information about a time interval between servo patterns output in the condition where the first signal is applied and an average value of the information about a time interval between servo patterns output in the condition where the first signal is not applied.

The information about a time interval between servo patterns may be output by measuring the number of clocks generated from the point where a servo gate pulse is generated to the point where a servo address mark included in the servo pattern is detected.

According to another feature of the general inventive concept, there is provided a method of detecting approximate touch-down of a head in a disk drive, the method including: detecting a change of an external force in a plurality of directions applied to the head by changing a flying height of the head on a rotating disk; and determining that the head approaches a touch-down approximated flying height when the detected change of the external force in the plurality of directions exceeds a threshold value.

The change of the external force in the plurality of directions may include at least a change of an external force in a disk track direction and a change of an external force in a disk radial direction.

The determining that the head approaches a touch-down approximated flying height may include: calculating a square root of the detected changes of the external force in the plurality of directions; comparing the calculated square root with a threshold value; and determining that the head approaches a touch-down approximated flying height when the calculated square root exceeds the threshold value as a result of the comparing.

The determining that the head approaches a touch-down approximated flying height may include: comparing the detected changes of the external force in the plurality of directions with initially set threshold values of changes of the external force in each direction; and determining that the head approaches a touch-down approximated flying height when at least one of the detected changes of the external force exceeds the threshold value of changes of the external force in a corresponding direction as a result of the comparing.

The change of the external force in the disk track direction included in the change of the external force in the plurality of directions may be output by performing a FFT for information about a time interval between servo patterns detected from a disk by the head according to a change of a flying height of the head and the change of the external force in the disk radial direction included in the change of the external force in the plurality of directions may be output by performing a FFT for information about a bias current used to offset a non-uniform external force in the disk radial direction applied to the head according to a change of a flying height of the head.

According to another feature of the general inventive concept, there is provided a method of adjusting a flying height of a head in a disk drive, the method including: outputting a profile of a change in a magnetic space between the head and a disk by changing a first signal, wherein the first signal is used to adjust a flying height of the head on a rotating disk; detecting a change in an external force of the head comprising at least a motion change of the head in a disk track direction according to the change of the first signal and determining that the head approaches a touch-down approximated flying height if the detected change in the external force of the head exceeds a threshold value; and determining the first signal that corresponds to a target flying height from the output profile of the change in the magnetic space between the head and the disk based on the first signal when the head approaches the touch-down approximated flying height.

The first signal may include a signal to determine a magnitude of power supplied to a heater installed in the head.

The change in the external force of the head may include a change in an external force in a disk track direction and a change in an external force in a disk radial direction.

The change in the external force in the disk track direction may be measured by a change in a time interval between servo patterns detected from a disk by the head according to a change of a flying height of the head and the change in the external force in the disk radial direction may be measured according to a change of a bias current used to offset a non-uniform external force in the disk radial direction applied to the head according to a change of a flying height of the head.

According to another feature of the general inventive concept, there is provided a disk drive including: a disk storing information; a head comprising a heater, recording information to the disk, and reading the information from the disk; and a controller outputting a profile of a change in a magnetic space between the head and the disk according to a change of a first signal, wherein the first signal is used to adjust power supplied to the heater, detecting a change in an external force applied to the head comprising a motion change of the head in a disk track direction according to the change of the power supplied to the heater and determining that the head approaches a touch-down approximated flying height, determining the first signal that corresponds to a target flying height of the head from the output profile of the change in the magnetic space between the head and the disk based on the first signal generated at the point when it is determined that the head approaches a touch-down approximated flying height.

The controller may determine that the head approaches a touch-down approximated flying height by detecting a change in the external force in the disk track direction applied to the head and detecting a change in the external force in the disk radial direction applied to the head according to a change of the power supplied to the heater and detecting a change in the external force in the disk radial direction based on a condition where the detected change in the external force in the disk track direction and a change in the external force in the disk radial direction are simultaneously reflected.

According to another feature of the general inventive concept, there is provided a computer readable recording medium having embodied thereon a computer code to execute the method of detecting approximate touch-down and the method of adjusting a flying height of a head.

In yet another feature, a disk drive comprises a spindle motor to rotate an axel, a disk disposed on the axel and including a plurality of tracks formed one next to another along a radial direction of the disk and each track circumnavigating the disk in a track direction that is transverse to the radial direction, a head to be raised and lowered above the disk and moveable along the radial direction and the track direction to read data from the disk and write data to the disk, and a control module that determines a jittering of the spindle motor and that determines a first force differential of a first external force applied to the head in the disk track direction and that determines a second force differential of a second external force applied to the head in the radial direction and that determines a touch-down approximated flying height of the head based on the jittering of the spindle motor and at least one of the first force differential and the second force differential.

In still another feature, a method of detecting approximate touch-down of a head in a disk drive including a disk having plurality of tracks formed one next to another along a radial direction of the disk and each track circumnavigating the disk in a track direction that is transverse to the radial direction includes detecting a jittering of the spindle motor and determining a jitter value according to the jittering of the spindle motor, determining a first force differential of a first external force applied to the head in the disk track direction and a second force differential of a second external force applied to the head in the radial direction, determining a touch-down approximated flying height based on only the first force differential of a first external force applied to the head in the disk track direction when the jitter value is at least one of less than and equal to a predetermined jitter threshold value, and determining a touch-down approximated flying height based on both the first force differential of the first external force applied to the head in the disk track direction and the second force differential of the second external force applied to the head in the radial direction when the jitter value exceeds the predetermined jitter threshold value.

### BRIEF DESCRIPTION OF THE DRAWINGS

The above and/or other features of the present general inventive concept will become apparent and more readily appreciated from the following description of the exemplary embodiments, taken in conjunction with the accompanying drawings, in which:

FIG. 1 is a block diagram of a data storage device, according to an exemplary embodiment of the general inventive concept;

FIG. 2 is a block diagram illustrating a software operating system of the data storage device illustrated in FIG. 1;

FIG. 3 is a plan view of a head disk assembly of a disk drive, according to an exemplary embodiment of the general inventive concept;

FIG. 4 is a block diagram illustrating an electric structure of a disk drive according to an exemplary embodiment of the general inventive concept;

FIG. 5 is a cross-sectional diagram of a head of a disk drive, according to an exemplary embodiment of the general inventive concept and a graph showing the relationship between the location of a heater and air bearing surface expansion;

FIG. 6 is a block diagram of a track following control device of a disk drive, according to an exemplary embodiment of the general inventive concept;

FIG. 7 is a block diagram of an apparatus to adjust a head flying height, according to an exemplary embodiment of the general inventive concept;

FIG. 8 is a block diagram of an apparatus to adjust a head flying height, according to another exemplary embodiment of the general inventive concept;

FIG. 9 illustrates a sector structure of one track of a disk which is a recording medium applied in the general inventive concept;

FIG. 10 illustrates a servo information field illustrated in FIG. 9;

FIG. 11 is a flowchart illustrating a method of adjusting a head flying height, according to an exemplary embodiment of the general inventive concept;

FIG. 12 is a flowchart illustrating a method of detecting approximate touch-down, according to an exemplary embodiment of the general inventive concept;

FIG. 13 is a flowchart illustrating a method of detecting approximate touch-down, according to another exemplary embodiment of the general inventive concept;

FIG. 14 is a flowchart illustrating a method of detecting approximate touch-down, according to another exemplary embodiment of the general inventive concept;

FIG. 15 illustrates an external force applied to a head by an interference between the head and a disk while performing a touch-down test, according to an exemplary embodiment of the general inventive concept;

FIG. 16 is a profile showing a touch-down approximated flying height of a head detected by applying a method of detecting a change in an external force in a radial direction and a profile showing a touch-down approximated flying height of a head detected by applying a method of detecting a change in an external force in a disk track direction, according to an exemplary embodiment of the general inventive concept;

FIG. 17 is a graph showing a change in a bias force according to a seek direction based on the location of a disk in a disk drive, according to an exemplary embodiment of the present general inventive concept;

FIG. 18 illustrate a profile H1 obtained by substantially measuring a touch-down flying height by using a method of physically contacting a head with a disk, a profile H2 obtained by detecting a touch-down approximated flying height of a head by only using a method of detecting a change in a bias current, and a profile H3 obtained by detecting a touch-down approximated flying height of a head by only using a method of detecting a change in a time interval between servo patterns; and

FIG. 19 is a flowchart illustrating a method of detecting approximate touch-down of a head in a disk drive according to an alternative exemplary embodiment of the present general inventive concept.

### DETAILED DESCRIPTION OF THE EMBODIMENTS

Embodiments of the general inventive concept will be described in more detail with reference to the accompanying drawings. The general inventive concept may, however, be embodied in many different forms and should not be construed as being limited to the embodiments set forth herein; rather, these embodiments are provided so that this disclosure will be thorough and complete, and will fully convey the concept of the present general inventive concept to those of ordinary skill in the art. In the drawings, like reference numerals denote like elements.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, embodiments of the general inventive concept will be described more fully with reference to the accompanying drawings.

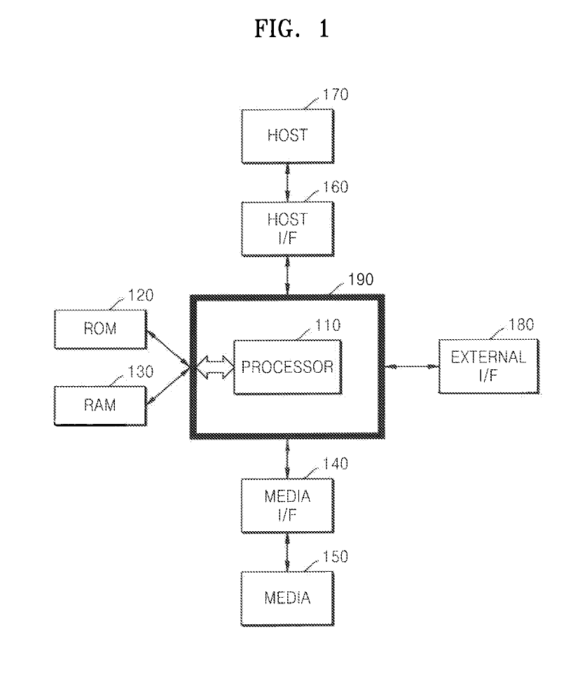

FIG. 1 is a block diagram of a data storage device, according to an exemplary embodiment of the general inventive concept. Referring to FIG. 1, the data storage device includes a processor 110, a read-only memory (ROM) 120, a random access memory (RAM) 130, a media interface (I/F) 140, a media 150, a host I/F 160, a host 170, an external I/F 180, and a bus 190.

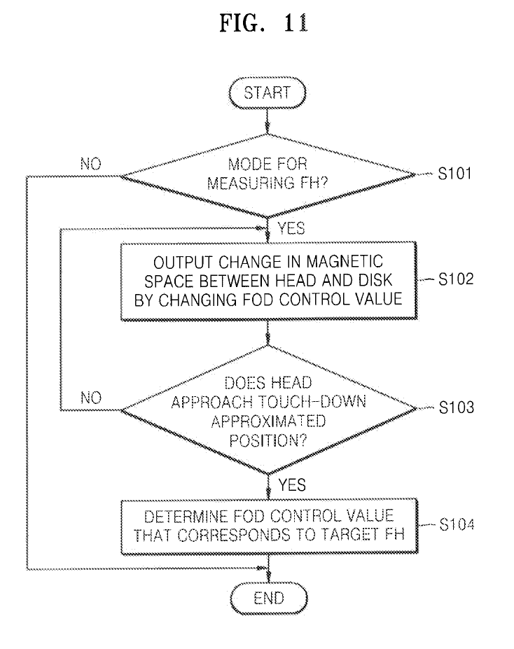

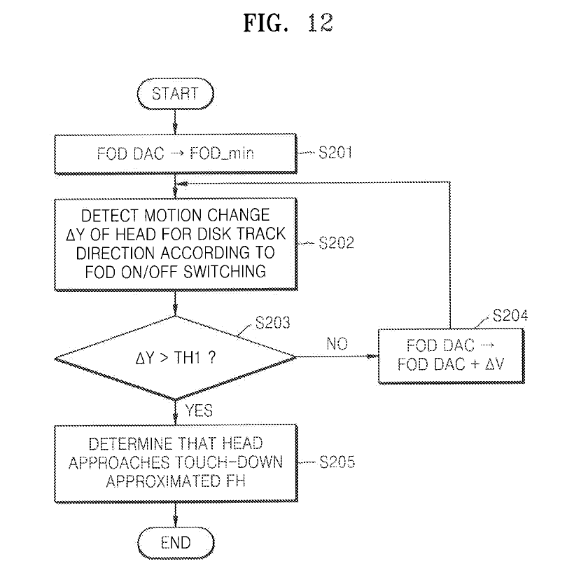

The processor 110 interprets an instruction and controls elements of the data storage device according to a result of the interpretation. The processor 110 includes a code object management unit, wherein the code object management unit is used to load a code object stored in the media 150 to the RAM 130. While initiating the data storage device, the processor 110 loads code objects to the RAM 130, wherein the code objects are used to execute a method of detecting approximate touch-down and a method of adjusting a head flying height using the detected approximate touch-down, which will be described later with reference to flowcharts of FIGS. 11-14.

Then, the processor 110 may detect a touch-down approximated flying height, execute a task to adjust a flying height of a head 16, and store information required to execute detecting of the approximate touch-down of a head 16 and adjusting of the head flying height to the media 150 or the ROM 120, by using the code objects loaded to the RAM 130 according to flowcharts of FIGS. 11 to 14. Examples of information required to execute detecting of the approximate touch-down of a head 16 and adjusting of the head flying height may include threshold values TH0, TH1, and TH2 and ΔV, wherein the threshold values TH0, TH1, and TH2 are used to determine a state of touch-down approximation and ΔV is a step increment of flying on demand (FOD) DAC value.

Detecting of a state of touch-down approximation of a head 16 is performed by the processor 110 and adjusting of a head flying height will be described more fully with reference to FIGS. 11-14.

The ROM 120 includes programs codes and data required to operate the data storage device.

Program codes and data stored in the ROM 120 or the media 150 are loaded to the RAM 130 according to control by the processor 110.

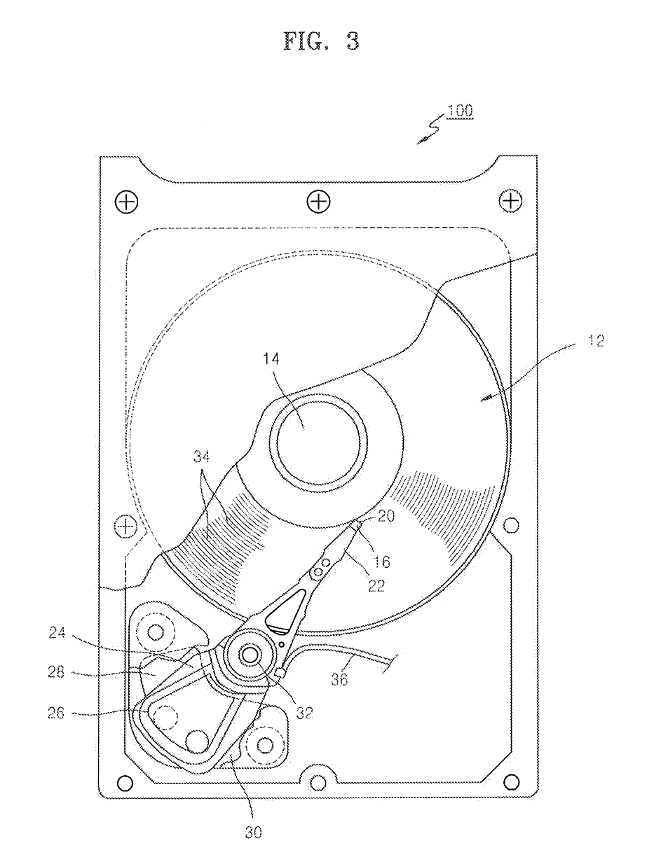

The media 150 is a main storage medium of the data storage device and may include a disk 12. The data storage device may include a disk drive. A head disk assembly 100 including a disk 12 and a head 16 in a disk drive is illustrated in FIG. 3.

FIG. 3 is a plan view of the head disk assembly 100 of a disk drive, according to an exemplary embodiment of the general inventive concept. Referring to FIG. 3, the head disk assembly 100 includes at least one disk 12 rotated by a spindle motor (SPM) 14. The disk drive also includes a head 16 located to be adjacent to the surface of the disk 12.

The head 16 senses a magnetic field of each of the at least one disk 12 and magnetizes each of the at least one disk 12, thereby reading or writing information from or to the rotating disk 12. In general, the head 16 is associated with the surface of each of the disk 12. Although a single head 16 is illustrated, it may be understood that the head 16 includes a head to write (i.e. a writer) to magnetize the disk 12 and a separate head (i.e. a reader) to read by sensing a magnetic field of the disk 12. The head 16 to read may include a magneto-resistive (MR) element. The head 16 may be also called a magnetic head or a transducer.

The head 16 may include a slider 20. The slider 20 generates air bearing between the head 16 and the surface of the disk 12. The slider 20 may include a head gimbal assembly 22. The head gimbal assembly 22 is coupled to an actuator arm 24 including a voice coil 26. The voice coil 26 may be located adjacent to a magnetic assembly 28 to define a voice coil motor (VCM) 30. A current applied to the voice coil 26 generates a torque to rotate the actuator arm 24 with respect to a bearing assembly 32. Due to the rotation of the actuator arm 24 about the bearing assembly 32, the head 16 may move across the disk 12.

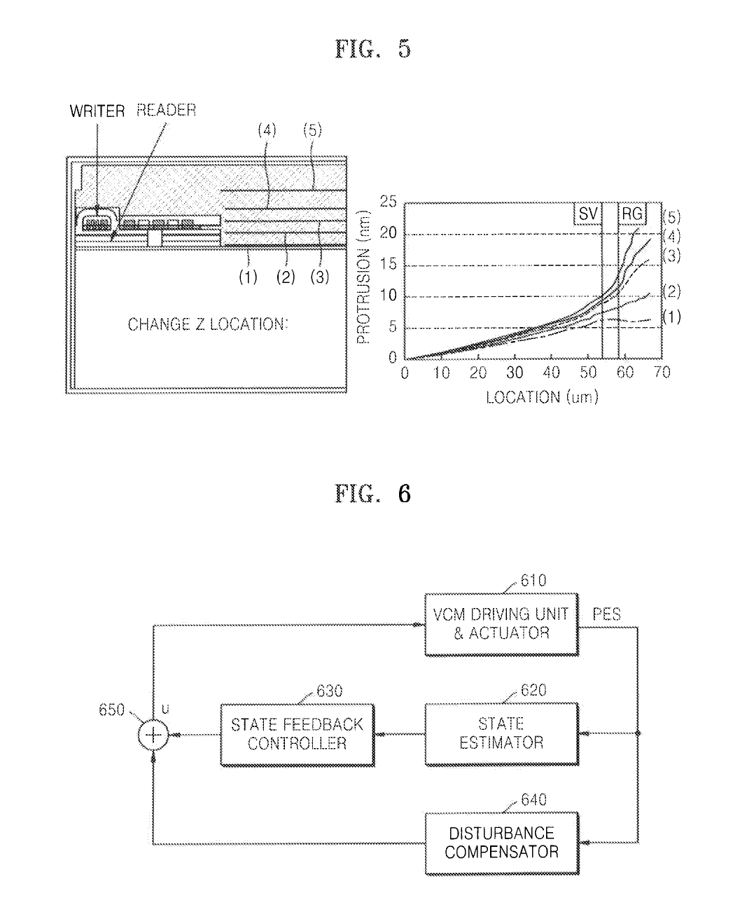

The slider 20 of the head 16 generates an air bearing surface on the surface of the disk 12 and between a reader and a writer. The head 16 further includes a heater to heat a structure used to generate the air bearing surface. The heater may be formed of a coil. As illustrated in FIG. 5, while a location Z of a coil corresponding to the heater is changed, a current is applied to the coil of the heater so as to measure expansion of the air bearing surface of a magnetic head and thus a location with an optimum expansion condition may be determined. In the graph illustrated in FIG. 5, the coil of the heater is installed at location 1 where the air bearing surface is uniformly expanded between a location SV of a reader and a location RG of a writer. When a current is applied to the heater installed in the head 16, heat expansion occurs at a pole tip, i.e., the end part of the head 16, and the flying height of the head 16 is reduced. That is, according to a change in the magnitude of a current or voltage applied to the heater, the flying height of the head 16 is adjusted.

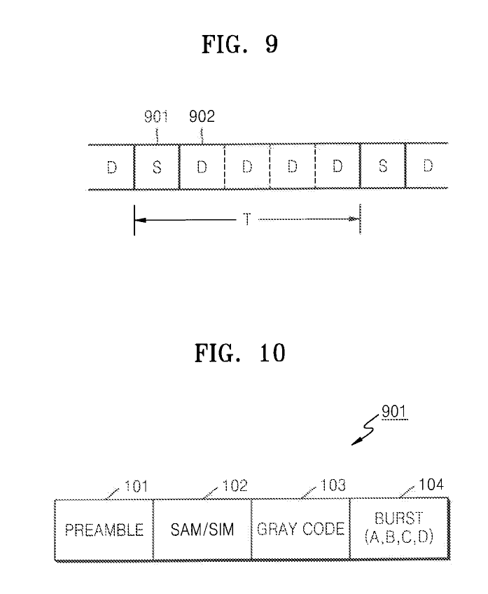

In general, information is stored in a circular track of the disk 12. Each track 34 generally includes a plurality of sectors. A structure of the sector of one track will now be described with reference to FIG. 9.

As illustrated in FIG. 9, at least one sector section T includes a servo information field 901 and a data field 902, The data field 902 includes a plurality of data blocks D. Further, at least one sector of the data field 902 may include one data block D. In addition, signals as illustrated in FIG. 10 may be written to the servo information field 901.

As illustrated in FIG. 10, a preamble 101, a servo synchronization indication signal 102, a gray code 103, and a burst signal 104 are written to the servo information field 901.

The preamble 101 provides clock synchronization when reading servo information and provides a regular timing margin by placing a gap before a servo sector. Also, the preamble 101 is used to determine a gain of an automatic gain control (AGC) circuit.

The servo synchronization indication signal 102 includes a servo address mark (SAM) and a servo index mark (SIM). The SAM is a signal indicating a start of a section and the SIM is a signal indicating a start of a first sector in a track included in the section.

The gray code 103 provides track information and the burst signal 104 is used to control the head 16 to follow the center of the track 34. For example, the burst signal 104 includes four patterns including A, B, C, and D. That is, four burst patterns are combined to generate a position error signal (PES) used to control track following.

Referring again to FIG. 3, a logic block address is allocated to a writable area of the disk 12. The logic block address in a disk drive is converted into cylinder/head/sector information and a writable area of the disk 12 is designated. The disk 12 includes a maintenance cylinder area, which a user may not access, and a user data area which a user may access. The maintenance cylinder area is also called a system area. Reallocated sector lists are stored in the maintenance cylinder area. Also, spare sectors which may replace a defect sector that may occur in a user environment may be designated in the disk 12. For example, a predetermined number of spare sectors may be designated by each track 34 or each zone. In the present general inventive concept, a writable area including the user data area and the maintenance cylinder area in the disk 12 is called a data area.

The head 16 moves across the surface of the disk 12 in order to read or write information stored in another track. A plurality of code objects may be stored in the disk 12 in order to realize various functions in a disk drive. For example, a code object to execute a MP3 player function, a code object to execute a navigation function, and a code object to execute various video games may be stored in the disk 12.

Referring again to FIG. 1, the media I/F 140 may be utilized by the processor 110 to access the media 150 and to write or read information. The media I/F 140 in the data storage device that is realized as a disk drive includes a servo circuit and a read/write channel circuit, wherein the servo circuit controls the head disk assembly 100 and the read/write channel circuit performs signal processing to data read/write.

The host I/F 160 is a means to process data transmission/reception to/from the host 170 such as a personal compute. The host I/F may include, but is not limited to, a serial advanced technology attachment (SATA) I/F, a parallel advanced technology attachment (PATA) I/F, and a universal serial bus (USB) I/F.

The external I/F is a means to process data transmission/reception to/from an external device through an input/output terminal installed in the data storage device. The external I/F. may include, but is not limited to, an accelerated graphics port (AGP) I/F, a USB I/F, an IEEE1394 I/F, a personal computer memory card international association (PCMCIA) I/F, a LAN I/F, a Bluetooth I/F, a High Definition Multimedia Interface (HDMI), a programmable communication interface (PCI), an Industry Standard Architecture (ISA) I/F, a peripheral component interconnect-express (PCI-E) I/F, an express card I/F, a SATA I/F, a PATA I/F, or a serial I/F.

Information is transmitted between elements of the data storage device via the bus 190.

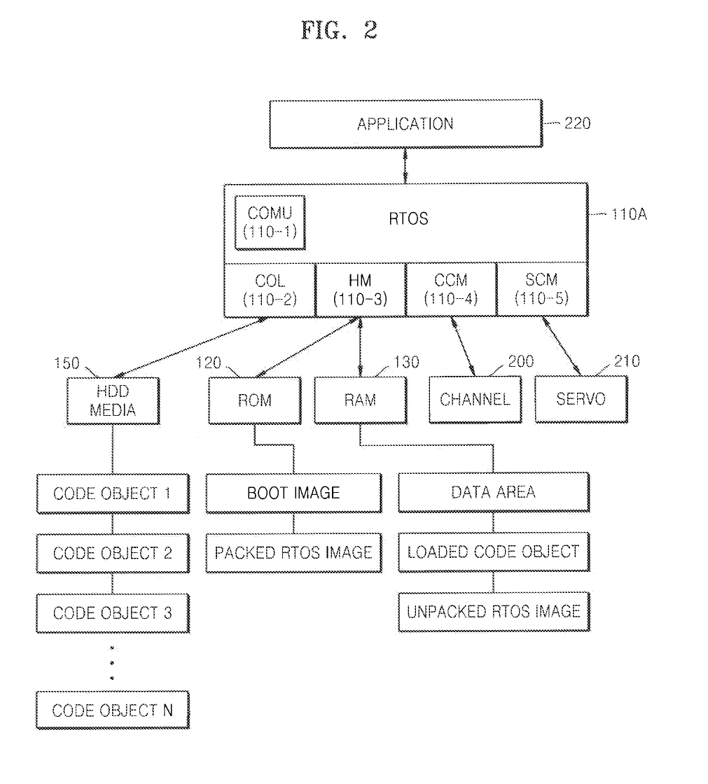

A software operating system of a disk drive, which is one example of the data storage device, will now be described more fully with reference to FIG. 2.

As illustrated in FIG. 2, the hard disk drive (HDD) media 150 includes a plurality of code objects 1 through N.

The ROM 120 may include a boot image and a packed real-time operating system (RTOS) image. The boot image includes a data file describing the contents and structure of hard disk drive (HDD), which may be utilized by a boot device to boot a host system. The RTOS may be utilized to operate real-time applications and/or control of hardware devices in real-time.

The plurality of code objects 1 through N are stored in a disk, which is the HDD media 150. The code objects stored in the disk may include not only code objects required to operate the disk drive but also code objects related to various functions to expand to the disk drive. In particular, code objects to execute a method of detecting approximate touch-down and a method of adjusting a head flying height using the detected approximate touch-down illustrated in FIGS. 11 through 14 may be stored in the disk. The code objects to execute the methods illustrated in FIGS. 11 through 14 may be also stored in the ROM 120 instead of the HDD media 150. In addition, code objects to execute various functions such as a MP3 player function, a navigation function, and a video game function may be stored in the disk.

A RTOS image is unpacked by reading the boot image from the ROM 120 while booting is loaded to the RAM 130. Then, code objects required to execute a host I/F and an external I/F stored in the HDD media 150 are loaded to the RAM 130.

A channel circuit 200 includes circuits required to execute signal processing of data read/write and a servo circuit 210 includes circuits required to control the head disk assembly 100 of data read/write.

A RTOS 110A is a multi program operating system using a disk. According to a task, real-time multi processing is performed in a foreground routine with a high priority and batch processing is performed in a background routine with a low priority. Also, in the RTOS 110A, loading of code objects from a disk and unloading of code objects to a disk are performed.

The RTOS 110A manages a code object management unit (COMU) 110-1, a code object loader (COL) 110-2, a memory handler (MH) 110-3, a channel control module (CCM) 110-4, and a servo control module (SCM) 110-5 and performs a task according to a requested command. Also, the RTOS 110A manages application programs 220.

More specifically, the RTOS 110A loads code objects required to control a disk drive to the RAM 130 during booting of the disk drive. Accordingly, after booting is performed, the code objects loaded to the RAM 130 may be used to operate the disk drive.

The COMU 110-1 stores information about the location to which code objects are recorded, converts a virtual address into a real address, and arbitrates a bus. Also, the COMU 110-1 stores information about priorities of executing tasks. In addition, the COMU 110-1 manages task control block (TCB) information required to execute tasks corresponding to code objects and stack information.

The COL 110-2 loads the code objects stored in the HDD media 150 to the RAM 130 by using the COMU 110-1 and unloads the code objects stored in the RAM 130 to the HDD media 150. Accordingly, the COL 110-2 may load code objects stored in the HDD media 150 to the RAM 130, wherein the code objects are used to execute the method of detecting approximate touch-down and the method of adjusting a head flying height using the detected approximate touch-down illustrated in FIGS. 11 through 14.

The RTOS 110A may execute the method of detecting approximate touch-down and the method of adjusting a head flying height using the detected approximate touch-down illustrated in FIGS. 11 through 14, which will be described below, by using the code objects loaded to the RAM 130.

The MH 110-3 writes and reads data to and from the ROM 120 and the RAM 130.

The CCM 110-4 performs channel control required to execute signal processing of data read/write and the SCM 110-5 controls a servo system including a head disk assembly to execute data read/write.

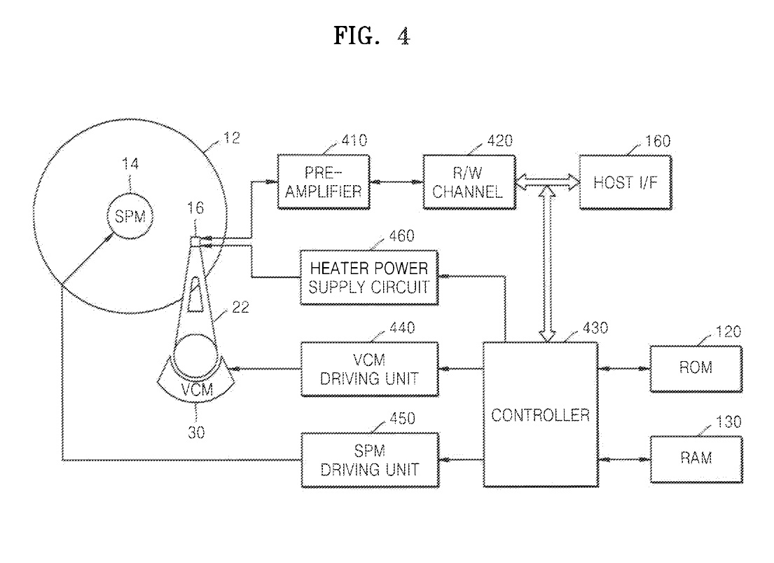

FIG. 4 is a block diagram illustrating an electric structure of a disk drive, which is an example of the data storage device illustrated in FIG. 1, according to an exemplary embodiment of the general inventive concept.

Referring to FIG. 4, the disk drive according to an exemplary embodiment of the general inventive concept includes a pre-amplifier 410, a read/write (R/W) channel 420, a controller 430, a voice coil motor (VCM) driving unit 440, a spindle motor (SPM) driving unit 450, a heater power supply circuit 460, the ROM 120, the RAM 130, and the host I/F 160.

The heater power supply circuit 460 supplies power that corresponds to a FOD DAC value applied from the controller 430 to a heater installed in the head 16. Here, the FOD DAC is a control signal to adjust a head flying height and determines a magnitude of a voltage or current applied to the heater installed in the head 16.

The heater power supply circuit 460 generates a current according to the FOD DAC value in a FOD ON condition and provides the generated current to the heater installed in the head 16. Also, the heater power supply circuit 460 inhibits a current applied to the heater installed in the head 16 in a FOD OFF condition.

The controller 430 may be a digital signal processor (DSP), a microprocessor, a microcontroller, or a processor. The controller 430 reads information from the disk 12 or controls the R/W channel 420 to write information to the disk 12 according to a command received from a host device through the host I/F 160.

The controller 430 is coupled to the VCM driving unit 440 that applies a driving current to drive the VCM 30. The controller 430 provides a control signal to the VCM driving unit 440 in order to control motion of the head 16.

The controller 430 is also coupled to the SPM driving unit 450 that applies a driving current to drive the SPM 14. When power is supplied, the controller 430 provides a control signal to the SPM driving unit 450 in order to rotate the SPM 14 at target speed.

The controller 430 is combined with the heater power supply circuit 460 and generates a FOD DAC, which is a control signal to determine a magnitude of the voltage or current to be applied to the heater installed in the head 16.

The controller 430 includes a track following control device that controls the head 16 to follow the center of the track 34 in the disk 12, as illustrated in FIG. 6.

Referring to FIG. 6, the track following control device includes a state estimator 620, a state feedback controller 630, a disturbance compensator 640 and a summing unit 650 in order to control a VCM driving unit & actuator 610.

The state estimator 620 performs a process to estimate state variables of head motion including a location of the head, speed, and control input information by using a state equation known from a position error signal (PES).

The state feedback controller 630 generates a state feedback control value obtained by multiplying a state feedback gain with the state variables of head motion estimated in the state estimator 620.

The disturbance compensator 640 estimates a disturbance component included in the PES by using an estimation filter (not illustrated), which is a well-known technology, and generates a disturbance compensation control value to compensate for the estimated disturbance component.

The summing unit 650 outputs a VCM control signal (u) to the VCM driving unit & actuator 610. The VCM control signal (u) may be obtained by adding the state feedback control value generated from the state feedback controller 630 and the disturbance compensation control value generated from the disturbance compensator 640.

Accordingly, the VCM driving unit 440 generates a current corresponding to the VCM control signal (u) and applies the generated current to the VCM 30 so that the head 16 follows the center of the track.

If an external force in an inner circumferential direction that is applied to the head 16 and an external force of an outer circumferential direction are the same as each other during track following control, a direct current (DC) component of a current applied to the VCM may be ‘0.’ If the an external force in an inner circumferential direction that is applied to the head 16 and an external force in an outer circumferential direction are not the same as each other, a DC component of a current applied to the VCM may be a value other than ‘0.’

The DC component of a current, i.e., a bias current, is applied to the VCM during track following control offsets a non-uniform external force in a disk direction that may be applied to the head 16.

Referring back to FIG. 4, the controller 430 is in communication with the ROM 120 and the RAM 130. The ROM 120 stores firmware and control data to control the disk drive. Also, program codes and information to execute the method of detecting approximate touch-down and the method of adjusting a head flying height using the detected approximate touch-down illustrated in FIGS. 11 through 14 may be stored in the ROM 120. The program codes and information to execute the method of detecting approximate touch-down and the method of adjusting a head flying height using the detected approximate touch-down illustrated in FIGS. 11 through 14 may be stored in the maintenance cylinder area of the disk 12, instead of in the ROM 120.

The controller 430 may load the program codes and information to execute the method of detecting approximate touch-down and the method of adjusting a head flying height using the detected approximate touch-down stored in the ROM 120 or the disk 12 to the RAM 130. The controller 430 may also control elements to execute the method of detecting approximate touch-down and the method of adjusting a head flying height using the detected approximate touch-down illustrated in FIGS. 11 through 14 by using the program codes and information loaded to the RAM 130.

A general data reading operation and data writing operation of a disk drive are described below.

In a data read mode, the disk drive amplifies an electrical signal corresponding to data stored on the disk, which is sensed by the head 16 from the disk 12 in the pre-amplifier 410. Then, a signal output from the pre-amplifier 410 is amplified in the R/W channel 420 by an automatic gain control circuit (not illustrated) that automatically varies a gain according to a magnitude of a signal. The amplified signal is converted into a digital signal and then is decoded, thereby detecting data. After an error correction process is performed in the controller 430 by using a Reed-Solomon code, which is an example of an error correction code, the error corrected data is converted into stream data and is transmitted to a host device through the host I/F 160.

In a data write mode, the disk drive receives data from a host device through the host I/F 160 and a symbol used in error correction by using the Reed-Solomon code is added to the received data in the controller 430. The data is appropriately encoded corresponding to a write channel by the R/W channel 420 and is written to the disk 12 through the head 16 using a write current amplified by the pre-amplifier 410.

Executing the method of detecting approximate touch-down and the method of adjusting a head flying height using the detected approximate touch-down in the disk drive is described more fully below.

Firstly, a principle of the method of detecting approximate touch-down is described.

In the head disk assembly 100 of the disk drive, whether the head 16 accurately touches a touch-down position needs to be detected by performing a touch-down test in order to adjust a head flying height to be a target flying height. The head flying height is a gap between the head 16 and the disk 12.

A signal read from the disk 12 through the head 16, for example, a position error signal (PES), may be used to perform a touch-down test. More specifically, a PES signal may be generated in response to the head 16 contacting the disk. Accordingly, a touch-down flying height may be accurately detected. However, a the physical contact may cause a problem such as damage to the head 16 and/or the disk 12.

Accordingly, an approximate touch-down is used to measure a head flying height in the present general inventive concept instead of using the PES signal generated in response to the head 16 contacting the disk 12. That is, a method of detecting a touch-down state of the head 16 just before the head 16 and the disk 12 contact each other is introduced in the present general inventive concept instead of actually contacting the head 16 and the disk 12.

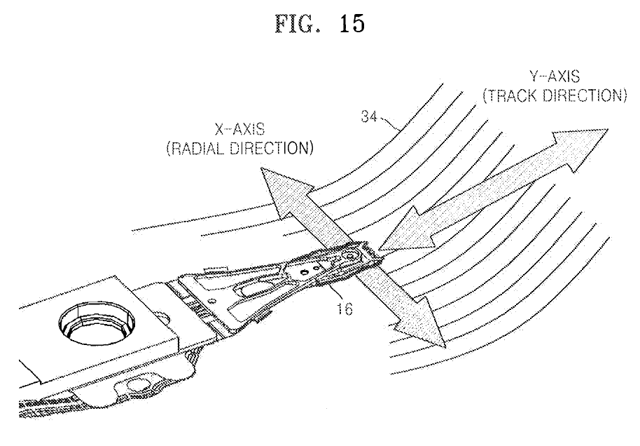

During rotation of the disk 12, an external force is induced between the head 16 and the disk. As a flying height of the head 16 lowers over the rotating disk 12, an external force applied to the head 16 increases by an interference according to a change in air flow between the head 16 and the disk 12. As illustrated in FIG. 15, an external force applied to the head 16 may include an external force in a disk radial direction (X-axis direction) and an external force in a track direction (Y-axis direction). The disk radial direction (i.e., X-axis direction) extends in a radial direction of the disk 12, and extends from the center of the disk 12 to the outer circumference of the disk 12. The track direction (i.e., Y-axis direction) extends in a direction that is transverse to the disk radial direction.

A change of the external force in a disk radial direction applied to the head 16 during track following may be represented by a change in bias current. As described above, the bias current denotes a DC component of a current applied to the VCM 30 and offsets a non-uniform external force in a disk radial direction applied to the head 16.

The external force in the disk radial direction applied to the head 16 when the head flying height is relatively high may be determined by a bias force applied by a flexible cable 36 shown in FIG. 3, which is connected to an actuator. A point where the bias force of the flexible cable 36 is zero may be widely distributed based on the center of a radius of the disk 12. If a current is not applied to the VCM 30, the VCM 30 receives a force from the flexible cable 36 to move to the center of the radius of the disk 12, which may be described as a bias force. The bias force is non-linearly changed by an influence of the flexible cable 36 based on each area of the disk 12 and a seek direction.

In FIG. 17, when the head 16 moves from the inner circumference of the disk 12 to the outer circumference, a change in the bias force is represented as a locus of C1. When the head 16 moves from the outer circumference of the disk 12 to the inner circumference, a change in the bias force is represented as a locus of C2. In FIG. 17, a horizontal axis represents track numbers and a vertical axis represents a bias current value.

Referring to FIG. 17, a point where the bias force is zero is formed around track number 12000 (indicated by a dotted line) and here, motion of the head 16 is suppressed by the a force of the flexible cable.

If the head flying height is lowered, a change of the external force in the disk radial direction due to interference of the head 16 and the disk 12 increases. The change in the external force in the disk radial direction applied to the head 16 may be detected by an amount of change in the bias current applied to the VCM 30. Accordingly, the amount of change in the bias current according to a change of the head flying height is detected so as to detect a state of the head 16 having reached a touch-down approximated flying height.

A DC offset of a current applied to the VCM does not occur during track following in a disk area where the bias force of the flexible cable 36 is zero. However, motion of the head 16 due to an interference of the head 16 and the disk 12 is suppressed by the bias force of the flexible cable 36 which is equally applied to an inner circumference direction of the disk 12 and an outer circumference direction of the disk 12. Thus, a touch-down test in a disk area where the bias force is zero may give abnormal results.

Accordingly, if a touch-down test is performed by monitoring only a change of the external force in the disk radial direction (X-axis direction) applied to the head 16, there is a high possibility of incorrectly determining a touch-down flying height in a disk area where the bias force is zero.

Therefore, a method of performing a touch-down test by using the external force in the disk track direction (Y-axis direction) applied to the head 16 is introduced in the present general inventive concept.

A change in the external force in the disk track direction applied to the head 16 may be detected by a timing change of motion of the head 16 in a track direction. That is, if a distance of an Nth servo pattern and a distance of an N+1th servo pattern are measured by an internal clock of the controller 430, motion of the head 16 in a track direction may be measured.

If a flying height of the head 16 is lowered, a change in the external force in the disk radial direction due to interference of the head 16 and the disk 12 increases and a change in the external force in the disk track direction applied to the head 16 may be detected by the amount of change in a time interval between servo patterns. Accordingly, the amount of change in the time interval between servo patterns according to a change of the flying height of the head 16 is detected so that a state in which the head 16 reaches the touch-down approximated flying height may be determined.

If a touch-down test is performed by using a change in the external force in the disk radial direction applied to the head 16, a condition to stably control the SPM 14 may be satisfied. That is, if the SPM 14 is not optimally controlled, jitter is significantly generated and motion of the head 16 in a track direction may not be accurately detected. However, if the SPM 14 is optimally controlled, motion of the head 16 in a track direction according to a change of a head flying height may be accurately detected in the entire area of the disk 12.

Accordingly, the method of detecting a touch-down state of the head 16 by using a change in the external force in the disk track direction (Y-axis direction) applied to the head 16 and the method of detecting a touch-down state of the head 16 by simultaneously using a change in the external force in the disk radial direction (X-axis direction) applied to the head 16 and a change in the external force in the disk track direction (Y-axis direction) are introduced in the present general inventive concept, as will be described more fully with reference to FIGS. 11 through 14.

An apparatus to adjust a head flying height according to an exemplary embodiment of the general inventive concept will also be described.

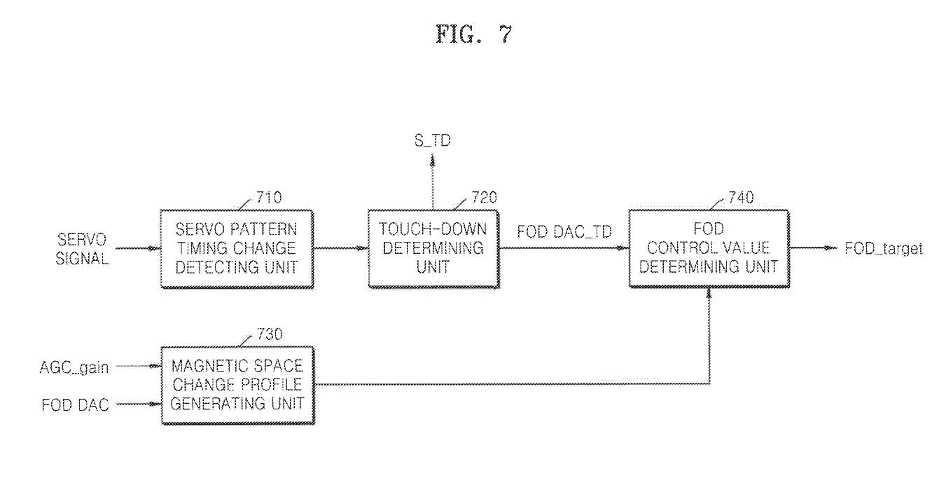

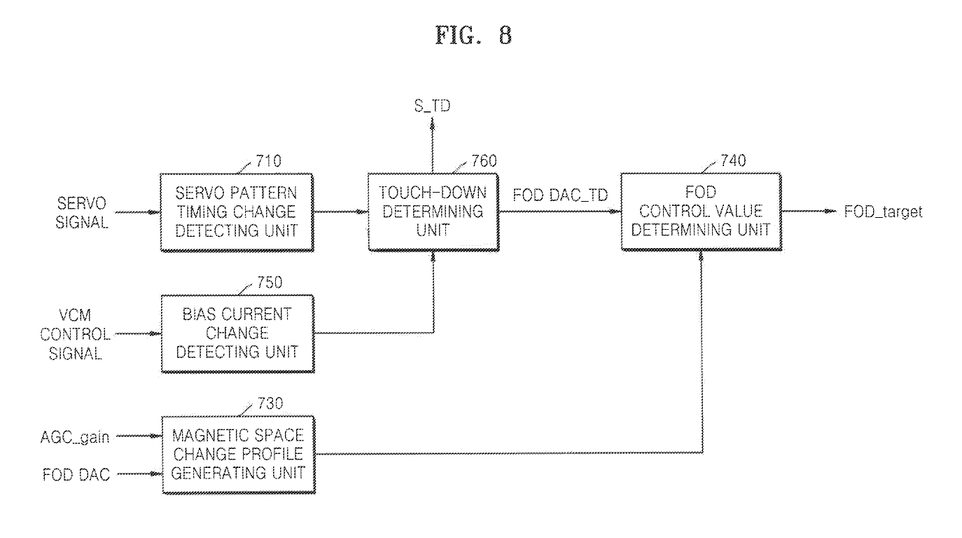

FIGS. 7 and 8 are block diagrams of an apparatus to adjust a head flying height, according to exemplary embodiments of the general inventive concept. The apparatus to adjust a head flying height, as illustrated in FIGS. 7 and 8, may be configured to be included in the processor 110 of the data storage device of FIG. 1 or the controller 430 of FIG. 4. In some cases, the apparatus to adjust a head flying height may be formed of separate circuits.

In the exemplary embodiments of the general inventive concept, the apparatus to adjust a head flying height, as illustrated in FIGS. 7 and 8, may be included in the processor 110 or the controller 430. For convenience of description, it is defined below that the apparatus to adjust a head flying height, as illustrated in FIGS. 7 and 8, is included in the controller 430.

First, the apparatus to adjust a head flying height, as illustrated in FIG. 7, according to an exemplary embodiment of the general inventive concept is described.

Referring to FIG. 7, the apparatus of adjusting a head flying height according to an exemplary embodiment includes a servo pattern timing change detecting unit 710, a touch-down determining unit 720, a magnetic space change profile generating unit 730, and a FOD control value determining unit 740.

The servo pattern timing change detecting unit 710 detects a change in a time interval between servo patterns detected from the disk 12 by the head 16 while performing a touch-down process that gradually lowers the flying height of the head 16. The change in time interval may be compared to a predetermined threshold value to determine when the head 16 approaches a touch-down approximated position, as discussed in greater detail below.

In a touch-down test mode to measure the flying height of the head 16, the controller 430 generates a condition for gradually increasing a FOD DAC value applied to the heater power supply circuit 460 and to repeat the FOD ON/OFF a predetermined number of times.

In such a touch-down test condition, the servo pattern timing change detecting unit 710 outputs information about a time interval between servo patterns to detect motion of the head 16 in a track direction. For example, the information about a time interval between servo patterns may be output by measuring the number of clocks generated from the point where a servo gate pulse is generated to the point where a servo address mark included in the servo pattern is detected.

In one example, the servo pattern timing change detecting unit 710 may detect the time interval between servo patterns by performing a fast Fourier transformation (FFT) on the information about a time interval between servo patterns output in the condition to gradually increase a FOD DAC value. The servo pattern timing change detecting unit 710 may then repeat the FOD ON/OFF, and output a change in a time interval between servo patterns according to FOD ON/OFF. Accordingly, if the information about a time interval between servo patterns is fast Fourier transformed with FOD ON/OFF frequency, which is a frequency of attention, a change in a time interval between servo patterns according to FOD ON/OFF may be easily obtained.

In another example, the servo pattern timing change detecting unit 710 may detect the time interval between servo patterns by outputting a change in a time interval between servo patterns according to the FOD ON/OFF by gradually increasing a FOD DAC value. The servo pattern timing change detecting unit 710 may then obtain an average value of the information about a time interval between servo patterns output in the FOD ON condition and an average value of the information about a time interval between servo patterns output in the FOD OFF condition, and calculate the difference between the average values.

The touch-down determining unit 720 compares a first threshold value TH1 with a change in the time interval between servo patterns according to FOD ON/OFF input from the servo pattern timing change detecting unit 710 so as to generate a signal S_TD indicating that the head 16 approaches a touch-down approximated position when the change in the time interval between servo patterns according to FOD ON/OFF exceeds the first threshold value TH1. Also, the touch-down determining unit 720 determines the applied FOD DAC value as a touch-down standard value. Here, the first threshold value TH1 is a threshold change of the time interval between servo patterns according to FOD ON/OFF to determine the touch-down approximated position where the head 16 and the disk 12 do not actually contact each other and may be experimentally determined when designing a disk drive, although the threshold value may also be dynamically determined based on various changing parameters of the hard disk drive. The controller 430 completes the touch-down process when the signal S_TD indicating that the head 16 approaches the touch-down approximated position is generated.

The magnetic space change profile generating unit 730 outputs a profile of a change in a magnetic space between the head 16 and the disk 12 according to a change of the FOD DAC value. For example, the change in the magnetic space between the head 16 and the disk 12 may be obtained by using a well-known Wallace spacing loss equation so that a profile of the flying height of the head 16 on the disk 12 according to the change of the FOD DAC value may be obtained.

The Wallace spacing loss equation is as in Equation 1.

Δd=(λ/2π)*Ls [Equation 1]

where Δd=a change in a magnetic space between the head 16 and the disk 12, λ=write wavelength=line velocity/write frequency, Ls=Ln(TAA1/TAA2), Ln is a natural logarithm, TAA1 is a previous AGC gain, and TAA2 is a current AGC gain.

Accordingly, a change in a magnetic space between the head 16 and the disk 12 with respect to a change in AGC gain may be obtained by using Equation 1. For reference, the AGC gain according to a change of the FOD DAC value may be measured so that a profile of a change in the magnetic space between the disk 12 and the head 16 according to a change of the FOD DAC value may be obtained.

The FOD control value determining unit 740 determines a FOD_target value, which is a FOD DAC value corresponding to a target standard flying height, from the profile of the change in the magnetic space between the disk 12 and the head 16 according to a change in the FOD DAC value obtained in the magnetic space change profile generating unit 730 based on FOD DAC_TD input from the touch-down determining unit 720.

Accordingly, the controller 430 may control the head flying height to be a target flying height by applying the FOD_target value determined in the FOD control value determining unit 740 as a FOD DAC value.

The apparatus to adjust a head flying height illustrated in FIG. 8, according to another exemplary embodiment of the general inventive concept will now be described.

Referring to FIG. 8, the apparatus of adjusting a head flying height according to an exemplary embodiment includes the servo pattern timing change detecting unit 710, a magnetic space change profile generating unit 730, the FOD control value determining unit 740, a bias current change detecting unit 750, and a touch-down determining unit 760.

The servo pattern timing change detecting unit 710, the magnetic space change profile generating unit 730, and the FOD control value determining unit 740 are described above with reference to FIG. 7 and thus a description thereof will not be repeated here.

As in FIG. 7, due to the touch-down process of the controller 430, the condition to gradually increase a FOD DAC value applied to the heater power supply circuit 460 to thereby lower the head 16, and repeating FOD ON/OFF a predetermined number of times is generated.

The bias current change detecting unit 750 detects a bias current change to detect a change in the external force in the disk radial direction applied to the head 16 while performing a touch-down test process. For example, in the condition to gradually increase a FOD DAC value and repeating FOD ON/OFF, the VCM control signal (u) that is output from the summing unit 650 of the track following control device illustrated in FIG. 6 is measured and a FFT is performed on the measured VCM control signal (u), thereby outputting a change in a bias current according to FOD ON/OFF. More specifically, when information about a bias current is fast Fourier transformed with FOD ON/OFF frequency, which is a frequency of attention, a change in a bias current according to FOD ON/OFF may be easily obtained.

Also, the bias current change detecting unit 750 may output a change in a bias current according to FOD ON/OFF by gradually increasing a FOD DAC value, obtaining an average value of the VCM control signals (u) output in the FOD ON condition and an average value of the VCM control signals (u) that are output in the FOD OFF condition, and calculating the difference between the average values.

The touch-down determining unit 760 determines that the head 16 approaches the touch-down approximated flying height based on a determination standard in which a change in the time interval between the servo patterns according to FOD ON/OFF input from the servo pattern timing change detecting unit 710 and a change in a bias current according to FOD ON/OFF input from the bias current change detecting unit 750 are simultaneously reflected. For example, square roots of the change in the time interval between the servo patterns according to FOD ON/OFF and the change in a bias current are calculated. When the calculated square roots exceed a third threshold value TH3, the signal S_TD indicating that the head 16 approaches the touch-down approximated position is generated and the applied FOD DAC value FOD DAC_TD is determined as a touch-down standard value. Here, the third threshold value TH3 is a threshold change, in which the change in the time interval between the servo patterns according to FOD ON/OFF and the change in a bias current are simultaneously considered, to determine the touch-down approximated position where the head 16 and the disk 12 do not actually contact each other and may be experimentally determined when designing a disk drive.

The touch-down determining unit 760 compares the first threshold value TH1 with the change in the time interval between servo patterns according to FOD ON/OFF and compares the second threshold value TH2 with the change in bias current. When the change in the time interval between servo patterns exceeds the first threshold value TH1, or when the change in bias current exceeds the second threshold value TH2, the signal S_TD indicating that the head 16 approaches the touch-down approximated position is generated and the applied FOD DAC value FOD DAC_TD is determined as a touch-down standard value. Here, the first threshold value TH1 is a threshold change of the time interval between servo patterns according to FOD ON/OFF to determine the touch-down approximated position where the head 16 and the disk 12 do not actually contact each other and the second threshold value TH2 is a threshold change of bias current according to according to FOD ON/OFF to determine the touch-down approximated position where the head 16 and the disk 12 do not actually contact each other, wherein the first threshold value TH1 and the second threshold value TH2 may be experimentally determined when designing a disk drive.

The controller 430 completes the touch-down process when the signal S_TD indicating that the head 16 approaches the touch-down approximated position is generated. The FOD control value determining unit 740 determines a FOD_target value, which is a FOD DAC value corresponding to a target standard flying height, from the profile of the change in the magnetic space between the disk 12 and the head 16 according to a change of the FOD DAC value obtained in the magnetic space change profile generating unit 730 based on FOD DAC_TD input from the touch-down determining unit 760.

The method of detecting approximate touch-down and a method of adjusting a head flying height using the detected approximate touch-down executed by control by a processor 110 of the data storage device of FIG. 1 or the controller 430 of the disk drive of FIG. 1 are described with reference to FIGS. 11 through 14. For convenience of description, it is defined below that the methods are executed by control by the controller 430. However, the general inventive concept is not limited thereto.

The method of adjusting a head flying height according to an exemplary embodiment of the general inventive concept will now be described with reference to FIG. 11.

In operation S101, the controller 430 determines whether the disk drive is transitioned to a mode to measure a flying height (FH) of the head 16. The mode to measure the FH of the head 16 may be executed during a test process after assembling the drive.

As a result of the determination in operation S101, when the disk drive is transitioned to a mode to measure the FH of the head 16, the controller 430 performs a process to output a change in a magnetic space between the head 16 and the disk by changing a FOD control value (FOD DAC value) so as to gradually decrease the FH of the head 16 in a disk zone in which the FH of the head 16 is to be measured, in operation S102. That is, a profile of the FH of the head 16 on the disk 12 with respect to a change of the FOD DAC value may be obtained by gradually increasing the FOD DAC value applied to the heater power supply circuit 460 due to control by the controller 430 and by using the Wallace spacing loss equation by amplitude as in Equation 1.

Whether the head 16 approaches the touch-down approximated position of the disk 12 is determined in operation S103 while performing operation S102. In a touch-down determination method introduced in the present general inventive concept, whether a physical touch-down, i.e., physical contact between the head 16 and the disk 12, actually occurs is not determined and instead whether the head 16 approaches the touch-down approximated position is determined. The touch-down approximated position is detected in order to output the FH of the head 16 by using a change in a magnetic space between the disk 12 and the head 16 with respect to a change of a FOD DAC value obtained in operation S102. A method of detecting approximate touch-down which detects that the head 16 approaches the touch-down approximated FH will be described more fully with reference to FIGS. 12 through 14.

In operation S104, as a result of the determination in operation S103, when it is determined that the FH of the head 16 approaches the touch-down approximated position, a FOD DAC value that corresponds to the target FH is determined as a FOD control value of a corresponding zone from the profile of a change in the magnetic space between the disk 12 and the head 16 according to a change of the FOD DAC value obtained in operation S102. That is, a FOD DAC value that corresponds to the target FH is obtained from the profile of a change in the magnetic space between the disk 12 and the head 16 according to a change of the FOD DAC value obtained in operation S102 based on a FOD DAC value at the point where the head 16 approaches the touch-down approximated position. Then, if the obtained FOD DAC value is applied to the heater power supply circuit 460, a pole tip of the head 16 is expanded by heat generated from the heater installed in the head 16 and the FH of the head 16 may be adjusted to the target FH.

If a test to measure the head 16 FH is performed in each zone of a disk or each area including a plurality of zones, A FOD DAC value that corresponds to the target FH may be obtained corresponding to each zone or each area. Also, if a test to measure the head 16 FH is performed in each area including a plurality of zones, an interpolation method or an extrapolation method is used to estimate a FOD DAC value that corresponds to the target FH in a non-measured zone.

The method of detecting approximate touch-down will be described more fully with reference to FIGS. 12 through 14.

FIG. 12 is a flowchart illustrating the method of detecting approximate touch-down based on a change in the external force in a disk track direction (Y-axis) applied to the head 16, according to an exemplary embodiment of the general inventive concept.

In operation S201, the controller 430 sets an initial FOD DAC value of a control signal that adjusts the FH of the head 16 in a touch-down test process as a minimum value FOD_min and the set FOD DAC value is applied to the heater power supply circuit 460. Here, the minimum value FOD_min may be set to ‘0.’

In operation S202, the controller 430 detects a motion change AY of the head 16 in a disk track direction according to FOD ON/OFF switching. For example, the motion change AY of the head 16 in a disk track direction according to FOD ON/OFF switching may be detected using a change in a time interval between the servo patterns. Then, the time interval between the servo patterns may be measured by the number of clocks generated from the point where servo gate pulse is generated to the point where servo address mark included in the servo pattern is detected.

More specifically, a FFT is performed on information about the time interval between the servo patterns output in the condition where the FOD ON/OFF is repeated a predetermined number of times in a predetermined time interval, so as to output a change in the time interval between the servo patterns according to FOD ON/OFF. More specifically, if the information about the time interval between servo patterns is fast Fourier transformed with FOD ON/OFF frequency, which is a frequency of attention, a change in the time interval between servo patterns according to FOD ON/OFF may be easily obtained.

Also, an average value of the information about the time interval between servo patterns output in the FOD ON condition and an average value of the information about the time interval between servo patterns output in the FOD OFF condition are obtained and the difference between the average values is calculated so that a change in the time interval between servo patterns according to FOD ON/OFF may be output.

Then, in operation S203, the controller 430 determines whether the motion change AY of the head 16 in the disk track direction detected in operation S202 exceeds the first threshold value TH1. Here, the first threshold value TH1 is a threshold change of the time interval between servo patterns according to FOD ON/OFF to determine the touch-down approximated position where the head 16 and the disk 12 do not actually contact each other and may be experimentally determined when designing a disk drive.

As a result of the determination in operation S203, if the motion change ΔY of the head 16 in the disk track direction does not exceed the first threshold value TH1, the currently set FOD DAC value increases by ΔV in operation S204 and operation S202 is performed again. Here, ΔV is a unit increment of a control signal, such as voltage, that adjusts the head 16 FH.

As a result of the determination in operation S203, if the motion change ΔY of the head 16 in the disk track direction exceeds the first threshold value TH1, it is determined that the head 16 approaches the touch-down approximated FH, in operation S205. That is, if the motion change ΔY of the head 16 in the disk track direction exceeds the first threshold value TH1, it is determined that the head 16 approaches the touch-down approximated FH so that the signal S_TD indicating that the head 16 approaches the touch-down approximated position is generated and the applied FOD DAC value FOD DAC_TD is determined as a touch-down standard value.

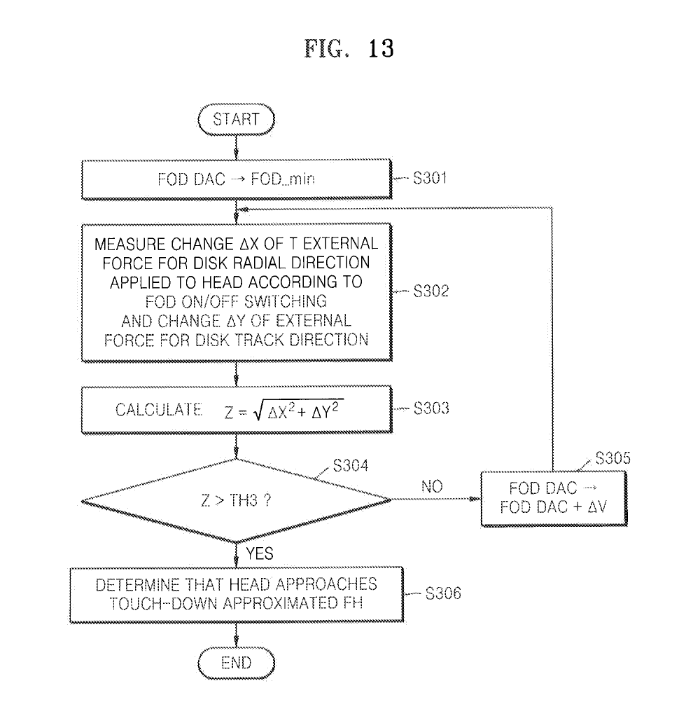

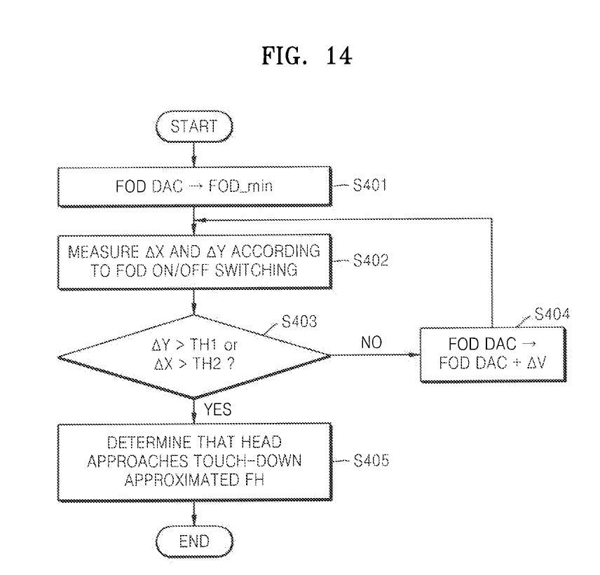

A method of detecting approximate touch-down according to another exemplary embodiment of the general inventive concept will now be described with reference to FIGS. 13 and 14.

Referring to FIGS. 13 and 14, a change of the external force in the disk radial direction (X-axis direction) applied to the head 16 and a change of the external force in the disk track direction (Y-axis direction) are simultaneously used in the method of detecting approximate touch-down.

The method of detecting approximate touch-down according to another exemplary embodiment of the general inventive concept will now be described with reference to FIG. 13.

In operation S301, the controller 430 sets an initial FOD DAC value of a control signal that adjusts the FH of the head 16 in a touch-down test process as a minimum value FOD_min and the set FOD DAC value is applied to the heater power supply circuit 460. Here, the minimum value FOD_min may be set to ‘0.’

In operation S302, the controller 430 detects a change ΔX of the external force in the disk radial direction applied to the head 16 and a change ΔY of the external force in the disk track direction according to FOD ON/OFF switching. For example, the change ΔX of the external force in the disk radial direction applied to the head 16 according to FOD ON/OFF switching may be detected using a change of a bias current. That is, the VCM control signal (u) output from the summing unit 650 of the track following control device illustrated in FIG. 6 are measured and a FFT is performed on the measured VCM control signal (u), thereby outputting a change in a bias current according to FOD ON/OFF. More specifically, information about a bias current is fast Fourier transformed with FOD ON/OFF frequency, which is a frequency of attention, a change in a bias current according to FOD ON/OFF may be easily obtained. Also, a change in a bias current according to FOD ON/OFF may be output by obtaining an average value of the VCM control signals (u) output in the FOD ON condition and an average value of the VCM control signals (u) output in the FOD OFF condition and calculating the difference between the average values.

In addition, the change ΔY of the external force in the disk track direction according to FOD ON/OFF switching may be detected using a change in the time interval between the servo patterns. That is, a FFT is performed on information about the time interval between the servo patterns output in the condition where the FOD ON/OFF is repeated a predetermined number of times in a predetermined time interval, so as to output a change in the time interval between the servo patterns according to FOD ON/OFF. More specifically, if the information about the time interval between servo patterns is fast Fourier transformed with FOD ON/OFF frequency, which is a frequency of interest, a change in the time interval between servo patterns according to FOD ON/OFF may be easily obtained. Also, an average value of the information about the time interval between servo patterns output in the FOD ON condition and an average value of the information about the time interval between servo patterns output in the FOD OFF condition are obtained and the difference between the average values is calculated so that a change in the time interval between the servo patterns according to FOD ON/OFF may be output.

In operation S303, the controller 430 calculates a square root Z of the change ΔX of the external force in the disk radial direction applied to the head 16 according to FOD ON/OFF switching in operation S302 and the change ΔY of the external force in the disk track direction.

Then, in operation S304, the controller 430 determines whether the square root Z of the change ΔX of the external force in the disk radial direction and the change ΔY of the external force in the disk track direction exceeds the third threshold value TH3. Here, the third threshold value TH3 is a threshold change, in which the change in the time interval between the servo patterns according to FOD ON/OFF and the change in a bias current are simultaneously considered, to determine the touch-down approximated position where the head 16 and the disk 12 do not actually contact each other and may be experimentally determined when designing a disk drive.

As a result of the determination in operation S304, if the square root Z of the change ΔX of the external force in the disk radial direction and the change ΔY of the external force in the disk track direction does not exceed the third threshold value TH3, the currently set FOD DAC value increases by ΔV in operation S305 and operation S302 is performed again.

As a result of the determination in operation S304, if the square root Z of the change ΔX of the external force in the disk radial direction and the change ΔY of the external force in the disk track direction exceeds the third threshold value TH3, it is determined that the head 16 approaches the touch-down approximated FH, in operation S306. That is, if the square root Z of the change ΔX of the external force in the disk radial direction and the change ΔY of the external force in the disk track direction exceeds the third threshold value TH3, it is determined that the head 16 approaches the touch-down approximated FH so that the signal S_TD indicating that the head 16 approaches the touch-down approximated position is generated and the applied FOD DAC value FOD DAC_TD is determined as a touch-down standard value.

A method of detecting approximate touch-down according to another exemplary embodiment of the general inventive concept will now be described with reference to FIG. 14.

Operations S401 and S402 illustrated in FIG. 14 are the same as operations S301 and S302 illustrated in FIG. 13 and thus the same descriptions will not be repeated here.

After operations S401 and S402 are performed, the controller 430 compares the first threshold value TH1 with the change ΔY of the external force in the disk track direction applied to the head 16 according to FOD ON/OFF and the second threshold value TH2 with the change ΔX of the external force in the disk radial direction so that whether the condition where the change ΔY of the external force in the disk track direction exceeds the first threshold value TH1 or the change ΔX of the external force in the disk radial direction exceeds the second threshold value TH2 is generated is determined in operation S403.

As a result of the determination in operation S403, if the change ΔY of the external force in the disk track direction does not exceed the first threshold value TH1 and if the change ΔX of the external force in the disk radial direction does not exceed the second threshold value TH2, the currently set FOD DAC value increases by ΔV in operation S404 and operation S402 is performed again.

As a result of the determination in operation S403, if the condition where the change ΔY of the external force in the disk track direction exceeds the first threshold value TH1 or the change ΔX of the external force in the disk radial direction exceeds the second threshold value TH2, it is determined that the head 16 approaches the touch-down approximated FH, in operation S405. That is, if the condition where the change ΔY of the external force in the disk track direction exceeds the first threshold value TH1 or the change ΔX of the external force in the disk radial direction exceeds the second threshold value TH2 is generated, it is determined that the head 16 approaches the touch-down approximated FH so that the signal S_TD indicating that the head 16 approaches the touch-down approximated position is generated and the applied FOD DAC value FOD DAC_TD is determined as a touch-down standard value.

FIGS. 13 and 14, illustrate exemplary methods of detecting approximate touch-down of the head 16 by simultaneously using the change of the external force in the disk radial direction (X-axis direction) applied to the head 16 and the change of the external force in the disk track direction (Y-axis direction), use of the square root of the change of the external force in the disk radial direction (X-axis direction) and the change of the external force in the disk track direction (Y-axis direction) and use of the result obtained by comparing each of the changes of the external force with threshold values are introduced. However, the present general inventive concept is not limited thereto and the approximate touch-down of the head 16 may be detected by considering the change of the external force in the disk track direction (Y-axis direction) and the change of the external force in the disk track direction (Y-axis direction) in various ways.

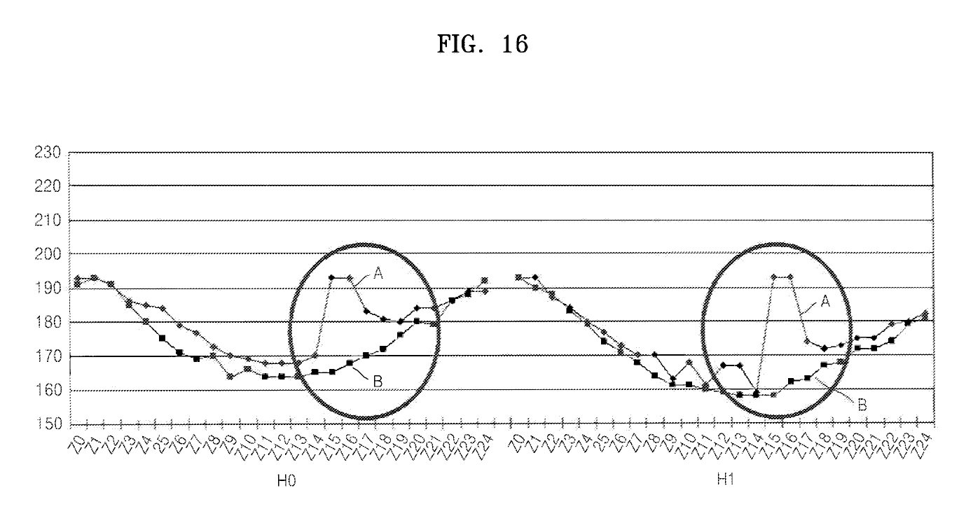

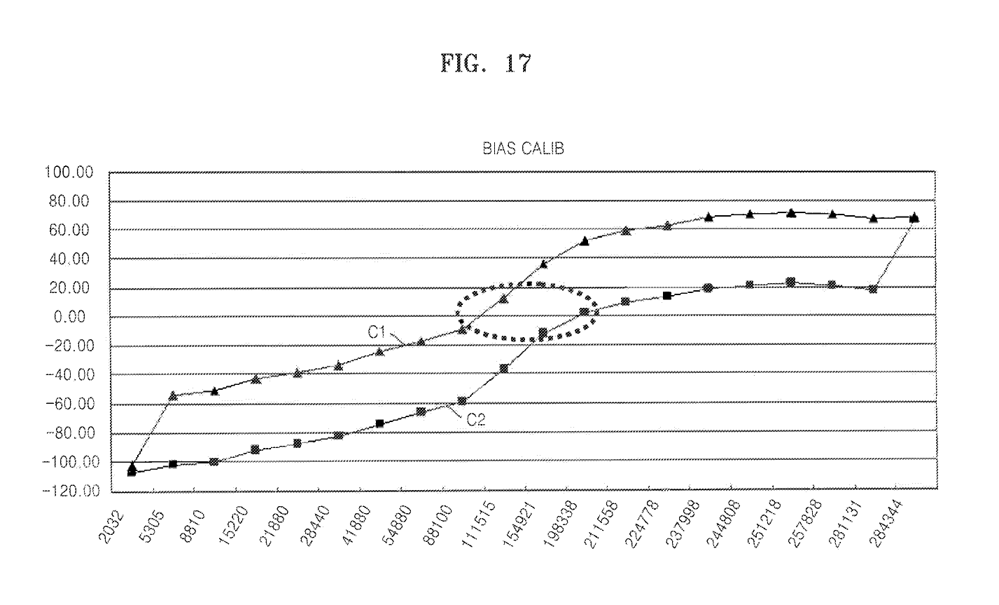

In FIG. 16, a touch-down approximated flying height detected by only applying the method of detecting the change of the external force in the disk radial direction (X-direction) by using a change of a bias current is represented by profile A and a touch-down approximated flying height detected by only applying the method of detecting the change of the external force in the disk track direction (Y-axis direction) by using a change of the time interval between the servo patterns is represented by profile B.

In FIG. 16, a horizontal axis represents a zone number of a disk and a vertical axis represents a FOD DAC value. The left side represents a profile of a touch-down approximated flying height of head 16 H0 and the right side represents a profile of a touch-down approximated flying height of head 16 H1.

Referring to FIG. 16, in profile A where the touch-down approximated flying height of the head 16 is detected using a change in bias current, the touch-down approximated flying height is abnormally detected in a bias force zero point area around the center of the radius of the disk. In profile B where the touch-down approximated flying height of the head 16 is detected using a change in the time interval between the servo patterns, the touch-down approximated flying height of the head 16 is detected in the entire area of the disk without an error.

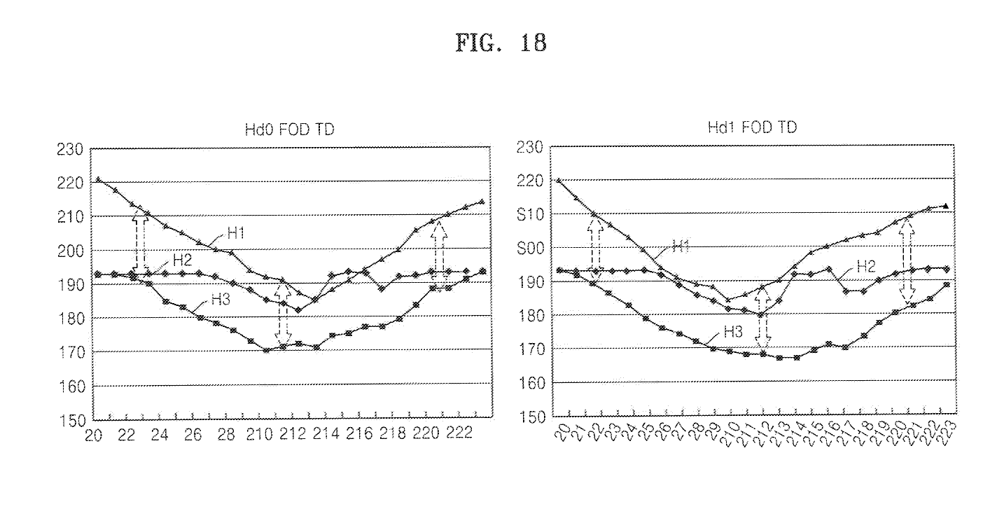

In FIG. 18, a profile H1 where the touch-down approximated flying height is actually measured by physically contacting the head 16 and the disk, a profile H2 where the touch-down approximated flying height of the head 16 is detected by applying only the method of detecting a change in bias current, and a profile H3 where the touch-down approximated flying height of the head 16 is detected by applying only the method of detecting a change in the time interval between the servo patterns are illustrated. In FIG. 18, a horizontal axis represents a zone number of a disk and a vertical axis represents a FOD DAC value.

Referring to FIG. 18, when the profile H1 where the touch-down approximated flying height is actually measured by physically contacting the head 16 and the disk is compared with the profile H3 where the touch-down approximated flying height of the head 16 is detected by applying only the method of detecting a change in the time interval between the servo patterns, a FH clearance at a regular interval exists over the entire area of the disk. On the other hand, the FH clearance is changed in each zone of the disk between the profile H1 where the touch-down approximated flying height is measured by physically contacting the head 16 and the disk and the profile H2 where the touch-down approximated flying height of the head 16 is detected by applying only the method of detecting a change in bias current.

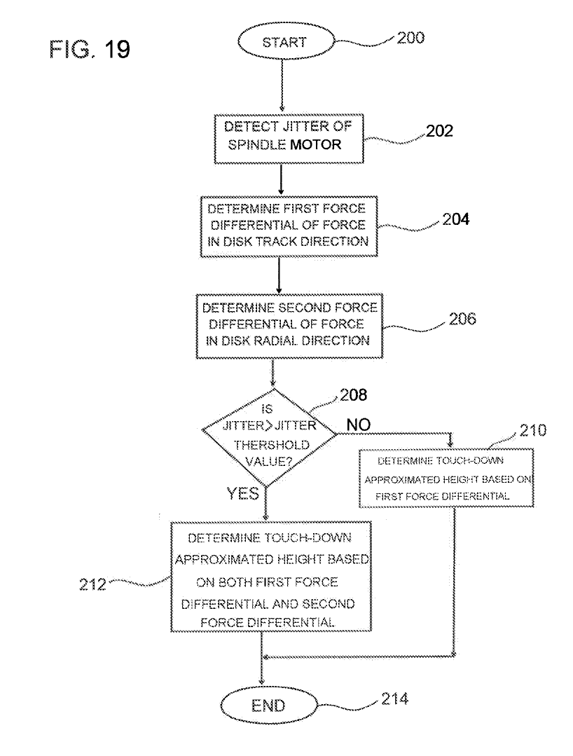

Referring now to FIG. 19, a method of detecting approximate touch-down of a head in a disk drive is described. The method begins in operation 200, and proceeds to operation 202 where jittering of the spindle motor (SPM) 14 is detected. A jitter value indicative of the amount of jitter in the SPM may be generated accordingly. In operation 204, a first force differential of a force in the disk track direction is determined. In operation 206, a second force differential of a force in the disk radial direction is determined. In operation 208, the amount of detected jitter, e.g., the jitter value, is compared to a predetermined jitter threshold value. When the jitter, e.g., jitter value, does not exceed the jitter threshold value, the touch-down approximated height is determined based on the first force differential of force in the disk track direction in operation 210, and the method ends in operation 214. However, if the jitter value exceeds the predetermine jitter threshold value, the touch-down approximated height is determined based on both the first force differential of force in the disk track direction and the second force differential in the disk radial direction in operation 212, and the method ends in operation 214.

Accordingly, in the detecting of the touch-down approximated flying height of the head 16 by only using a method of detecting a change in a time interval between servo patterns, the touch-down approximated flying height of the head 16 is detected more accurately than the detecting of the touch-down approximated flying height of the head 16 by only using a method of detecting a change in bias current.

However, when the touch-down approximated flying height of the head 16 is detected by only using a method of detecting a change in a time interval between servo patterns, stability of a SPM control circuit may be reduced and jitter may significantly occur so that a significant detection error of the touch-down approximated flying height may be generated in the entire area of the disk.

Accordingly, if the SPM control circuit may be designed to secure its stability in the disk drive, the touch-down approximated flying height of the head 16 may be detected by only using a method of detecting a change of external force in the disk track direction (Y-direction), e.g., based on a change in a time interval between servo patterns.

However, if jitter with a regular value or above occurs in the SPM control circuit of the disk drive, a change of the external force in the disk track direction (Y-axis direction) and a change of the external force in the disk track direction (Y-axis direction) may be simultaneously considered to detect the touch-down approximated flying height of the head 16.

The present general inventive concept may be executed as a method, an apparatus, or a system. When executing as software, elements of the present general inventive concept are code segments to execute required operations. Programs or code segments may be stored in a processor readable medium.

Although a few exemplary embodiments of the present general inventive concept have been shown and described, it would be appreciated by those skilled in the art that changes may be made in these exemplary embodiments without departing from the principles and spirit of the general inventive concept, the scope of which is defined in the claims and their equivalents.

What is claimed is:

1. A method of detecting approximate touch-down of a head in a disk drive that moves in a disk radial direction extending from an inner circumference of the disk to an outer circumference of the disk and a that moves in a disk track direction that is transverse to the disk radial direction, the method comprising:
detecting a motion change of the head in the disk track direction by changing a flying height of the head over a rotating disk; and
determining that the head approaches a touch-down approximated flying height when the detected motion change of the head in the disk track direction exceeds a threshold value.

2. The method of claim 1, wherein the motion change of the head in the disk track direction is detected by using a change in a time interval between servo patterns detected from the disk according to a change in the flying height of the head.

3. The method of claim 1, wherein the flying height of the head is changed by changing a least one of a voltage and a current of a first signal applied to a heater installed in the head.

4. The method of claim 1, wherein the detecting of the motion change of the head in the disk track direction comprises:
outputting information about a time interval between servo patterns detected from the disk by the head in a condition where the first signal is applied by changing a magnitude of the first signal and in a condition where the first signal is not applied, wherein the first signal is used to adjust the flying height of the head; and
outputting the motion change of the head in the disk track direction by using a change between information about a time interval between servo patterns output in the condition where the first signal is applied and information about a time interval between servo patterns output in the condition where the first signal is not applied.

5. The method of claim 4, wherein the motion change of the head in the disk track direction is output by performing a fast Fourier transformation (FFT) on a time interval between servo patterns detected while repeating the condition where the first signal is applied and the condition where the first signal is not applied.

6. The method of claim 4, wherein the motion change of the head in the disk track direction is output by calculating a difference between an average value of the information about a time interval between servo patterns output in the condition where the first signal is applied and an average value of the information about a time interval between servo patterns output in the condition where the first signal is not applied.

7. The method of claim 4, wherein the information about a time interval between servo patterns is output by measuring the number of clocks generated from the point where a servo gate pulse is generated to the point where a servo address mark included in the servo pattern is detected.

8. A method of detecting approximate touch-down of a head in a disk drive, the method comprising:
detecting a change of an external force applied to the head in a plurality of directions by changing a flying height of the head on a rotating disk; and
determining that the head approaches a touch-down approximated flying height when the detected change of the external force in the plurality of directions exceeds a threshold value.

9. The method of claim 8, wherein the change of the external force in the plurality of directions comprises at least a change of an external force in a disk radial direction extending from an inner circumference of the disk to an outer circumference of the disk and a change of an external force in a disk track direction that is transverse to the disk radial direction.

10. The method of claim 8, wherein the determining that the head approaches a touch-down approximated flying height comprises:
calculating a square root of the detected changes of the external force in the plurality of directions;
comparing the calculated square root with a threshold value; and
determining that the head approaches a touch-down approximated flying height when the calculated square root exceeds the threshold value as a result of the comparing.

11. The method of claim 8, wherein the determining that the head approaches a touch-down approximated flying height comprises:
comparing the detected changes of the external force in the plurality of directions with initially set threshold values of changes of the external force in each direction; and
determining that the head approaches a touch-down approximated flying height when at least one of the detected changes of the external force exceeds the threshold value of changes of the external force in a corresponding direction as a result of the comparing.

12. The method of claim 8, wherein the change of the external force in the disk track direction included in the change of the external force in the plurality of directions is output by performing a FFT on a time interval between servo patterns detected from a disk by the head according to a change of a flying height of the head and the change of the external force in the disk radial direction included in the change of the external force in the plurality of directions is output by performing a FFT on a bias current used to offset a non-uniform external force in the disk radial direction applied to the head according to a change of a flying height of the head.

13. A method of adjusting a flying height of a head in a disk drive, the method comprising:
outputting a profile of a change in a magnetic space between the head and a disk by changing a first signal, wherein the first signal is used to adjust a flying height of the head on a rotating disk including a plurality of tracks formed one next to another along a disk radial direction of the disk and each track circumnavigating the disk in a disk track direction that is transverse to the radial direction;
detecting a change in an external force of the head comprising at least a motion change of the head in the disk track direction according to the change of the first signal and determining that the head approaches a touch-down approximated flying height if the detected change in the external force of the head exceeds a threshold value; and
determining the first signal that corresponds to a target flying height from the output profile of the change in the magnetic space between the head and the disk based on the first signal when the head approaches the touch-down approximated flying height.

14. The method of claim 13, wherein the first signal comprises a signal to determine a magnitude of power supplied to a heater installed in the head.

15. The method of claim 13, wherein the change in the external force of the head comprises a change in an external force in a disk track direction and a change in an external force in a disk radial direction.

16. The method of claim 15, wherein the change in the external force in the disk track direction is measured by a change in a time interval between servo patterns detected from a disk by the head according to a change of a flying height of the head and the change in the external force in the disk radial direction is measured according to a change of a bias current used to offset a non-uniform external force in the disk radial direction applied to the head according to a change of a flying height of the head.

17. A disk drive comprising:
a disk including a plurality of tracks formed along a disk radial direction of the disk and each track circumnavigating the disk in a disk track direction that is transverse to the radial direction;
a head to at least one of record data to at least one track, and read data from at least one track and including a heater; and
a controller that determines a change in a magnetic space between the head and the disk according to a change of a first signal that adjusts power supplied to the heater, and that determines a change of power supplied to the heater based on the change of the first signal, and that detects a change of an external force applied to the head in the disk track direction according to the change of power supplied to the heater, and that detects when the head approaches a touch-down approximated flying height, and that determines that the first signal corresponds to a target flying height of the head in response to detecting that the head approaches the touch-down approximated flying height.

18. The disk drive of claim 17, wherein the controller determines that the head approaches a touch-down approximated flying height by detecting a change in the external force applied to the head in the disk track direction and detecting a change in the external force applied to the head in the disk radial direction according to the change of the power supplied to the heater and detecting a change in the external force in the disk radial direction based on a condition where the detected change in the external force in the disk track direction and a change in the external force in the disk radial direction are simultaneously reflected.

19. The disk drive of claim 17, wherein the change in the external force in the disk track direction is generated by measuring a change in a time interval between servo patterns that are included with the disk and detected by the head.

20. A disk drive comprising:
a spindle motor to rotate an axel;
a disk disposed on the axel and including a plurality of tracks formed one next to another along a radial direction of the disk and each track circumnavigating the disk in a track direction that is transverse to the radial direction;
a head to be raised and lowered above the disk and moveable along the radial direction and the track direction to read data from the disk and write data to the disk; and
a control module that determines a jittering of the spindle motor and that determines a first force differential of a first external force applied to the head in the disk track direction and that determines a second force differential of a second external force applied to the head in the radial direction and that determines a touch-down approximated flying height of the head based on the jittering of the spindle motor and at least one of the first force differential and the second force differential.

21. The disk drive of claim 20, wherein the control module determines a jitter value according to the jittering of the spindle motor and determines the touch-down approximated flying height based on the first force differential of a first external force applied to the head in the disk track direction when the jitter value is less than a predetermined jitter threshold value.

22. The disk drive of claim 21, wherein the control module determines the touch-down approximated flying height based on both the first force differential of the first external force applied to the head in the disk track direction and the second force differential of the second external force applied to the head in the radial direction when the jitter value exceeds the predetermined jitter threshold value.

23. A method of detecting approximate touch-down of a head in a disk drive including a disk having plurality of tracks formed one next to another along a radial direction of the disk and each track circumnavigating the disk in a track direction that is transverse to the radial direction, the method comprising:
detecting a jittering of the spindle motor and determining a jitter value according to the jittering of the spindle motor;
determining a first force differential of a first external force applied to the head in the disk track direction and a second force differential of a second external force applied to the head in the radial direction;
determining a touch-down approximated flying height based on only the first force differential of a first external force applied to the head in the disk track direction when the jitter value is at least one of less than and equal to a predetermined jitter threshold value; and
determining a touch-down approximated flying height based on both the first force differential of the first external force applied to the head in the disk track direction and the second force differential of the second external force applied to the head in the radial direction when the jitter value exceeds the predetermined jitter threshold value.
